(19) United States
(12) Patent Application Publication
(10) Pub. No.: US 2003/0182306 A1
(43) Pub. Date: Sep. 25, 2003

(54) Content delivery server and content delivery system having the same

(76) Inventor: Yukitoshi Maeda, Nara (JP)

Correspondence Address: PITNEY, HARDIN, KIPP & SZUCH LLP, 685 THIRD AVENUE, NEW YORK, NY, 10017-4024, US

(21) Appl. No.: 10/333,110

(22) PCT Filed: Jul. 25, 2002
(86) PCT No.: PCT/JP02/07562

(30) Foreign Application Priority Data
Sep. 18, 2001 (JP) JP2001-283933

(51) Int. Cl. G06F 17/00

(52) U.S. Cl. 707/103 R

(57) ABSTRACT

The present invention offers a file distribution system that can restrict the use of files within a certain limit. The system includes a file distribution server. The file distribution server 2 is set up so that it can be connected with user terminals via communication network 3. The server 2 consists of several units. The units included are: the file data memory 24 to store digital file data to distribute, the program memory 25 to store a computer program to manage and play back digital file data, and the transfer-processing unit 26 to transfer management/playback program and digital file data in response to the request from user terminals. The management/playback program carries out the following processes: making storage space on the user terminals to store digital file data, storing the distributed digital file data after converting it to divided-and-spread data group according to certain rules, restoring the stored converted-file data to original digital file data by re-converting the converted-file data according to the rules, and playing back the restored digital file data.

### FIELD OF THE INVENTION

The present invention relates to a server for file distribution and file distribution system therewith. The server and the system are constructed to distribute various files to user computers, which are connected to a communication network such as the Internet.

### BACKGROUND

In general, music productions are copied onto various media, such as records, CDs (compact discs), and cassettes, and then they are sold in stores, or rented for a limited period. Movie productions are also copied into media such as videotapes and DVDs (digital video discs), and are sold or rented in stores. In addition, game programs for playing on computers (software games) are recorded in media such as CD-ROMs, and sold in stores. Novels are also sold in stores as publications.

### DISCLOSURE OF THE INVENTION

However, these measures for selling or renting productions require users to come to stores. If users have little spare time, they may miss the opportunities for purchasing or renting those productions. Therefore, these measures are not necessarily convenient for users.

On the other hand, recently the Internet has proliferated, and transactions using the Internet (online transactions) have increased. These online transactions are highly convenient because users need not go to stores. In this regard, nowadays distribution systems for digital files (music, movies, software games, novels, etc) are constructed on the Internet as web pages. Users can access the web pages with their computers (terminals), and download the digital files.

The digital files, which are the objects of the distribution system, are often copies of productions. Since copyrights of authors are valid for these digital files, further production and renting of the files are basically prohibited without permission of the authors. Therefore, in those distribution systems, when distributing the digital files, it is necessary to properly acquire permission of the authors.

However, regardless of whether users are aware of it or not, those distribution systems make copies of the files on the users' computers when the files are distributed, and make it possible for the users to use the copies continually. Therefore, in the case of rental, for which users are supposed to use the files for a limited period, rights of authors are invaded if the copies made on user computers cannot be properly deleted after the end of rental periods.

In spite of this fact, effective techniques for deleting copies from user computers, after rental periods, have not been developed, so far. Thus, the present-day distribution systems inevitably adopt the method of selling the files, rather than that of renting. In order to activate online transactions further, the development of the copy-deleting techniques has been sought.

Additionally, since digital files are easy to copy, from the point of view of proper copyright protection, it is desirable to develop effective techniques to prevent piracy of the files.

The present invention has been made in consideration of the above. The present invention relates to a server for file distribution and to a file distribution system therewith. The server and the system make it difficult to copy digital files, and they can delete distributed digital files properly after the expiration of user licenses. Therefore, the server and the system make it possible to effectively restrict the use of files to a certain limit.

The present invention, indicated in claim 1, for attaining the above purpose is:

A server for file distribution connected to a user terminal through a communication network comprising:

a file data memory having digital file data to be transmitted;

a program memory having a computer program managing and playing back said digital file data;

a management/playback program stored in said program memory requested from said user terminal; and

a transfer processing unit transferring said digital file data stored in said file data memory;

wherein said management/playback program performs a step of setting a storage space of said digital file data transferred from said file distribution server into a memory of said user terminal,

a step of storing said digital file data converted to a data group divided and spread by a setting rule in said storage space of said digital file data,

a step of decoding said data group stored in said memory of said user terminal to said digital file data by said setting rule, and

a step of playing back said decoded digital file data on said user terminal.

According to this file distribution server, if a user terminal accesses the file distribution server via a communication network, and then the server receives requests for distribution of certain or user-selected digital files, the server transfers the management/playback program stored in the program memory to the user terminal that accessed the server.

Next, when the management/playback program is started on the user terminal, the program makes storage space in the user terminal for data that are to be transferred from the file distribution server. Then, after completing this process, the server transfers the requested digital file data to the user terminal.

In the user terminal, the transferred digital file data are then converted into divided-and-spread data group by the management/playback program in accordance with a certain setting rule. The digital file data are finally stored in the storage space of the user terminal made in the preceding process.

This ends the distribution process of the digital file in the file distribution server.

When the digital file data are distributed to the user terminal in the way described above, the user can play back the digital file by starting and running the management/playback program, which is stored in the user terminal. In other words, when the management/playback program is run, the digital file data stored in the memory of the user terminal are re-converted and restored according to the setting rule, and then the restored digital file data are played on the user terminal.

In this way, with the file distribution server, the requested digital file data are stored in user terminals in the form of divided-and-spread data group, which are converted according to the setting rule. Therefore, without the management/playback program, which can re-convert the file data by using the setting rule sent with the data, the transferred file cannot be played back. Thus, even if transferred digital file (converted digital file) are copied, general playback programs cannot play back the copied file. Furthermore, by converting file data into divided-and-spread data group, analyzing and restoring the data become difficult. Therefore, the system makes it possible to effectively prevent illegal use of transferred files and to prevent file piracy and distribution.

According to the invention indicated in claim 2 of the present invention, there is a setting rule that is unique to each one of its users. The setting rule corresponds to the above setting rule of the file distribution server indicated in the above claim 1. According to this file distribution server, digital file data cannot be played back without the management/playback program transferred to the user terminal even when the file distribution server transfers the management/playback program to other user terminals because the setting rule is unique to each one of its users and each management/playback program is not compatible with other management/playback programs. Therefore, the file distribution server makes it possible to prevent piracy by illegal copying of the transferred digital files among users.

According to the invention indicated in claim 3 of the present invention, there is a transfer processing unit (that corresponds to the transfer processing unit of the file distribution server indicated in the claim 1 or 2) transferring the digital file data requested from the user terminal with a deletion condition data, the management/playback program performing a step of setting a storage space of the digital file data and the deletion condition data transferred from the file distribution server into the memory of the user terminal, a step of storing the digital file data converted to data group divided and spread by the setting rule in the storage space with the deletion condition data, a step of decoding the converted file data group stored in the memory of the user terminal to the digital file data by the setting rule, a step of playing back the decoded digital file data on the user terminal, a step of comparing the deletion condition, and a step of deleting the converted digital file data stored in the memory of the user terminal when the deletion condition is satisfied.

According to this file distribution server, besides the above steps of the file distribution server indicated in claim 1 or 2, when the management/playback program is run, in playing back of the digital file, the deletion condition data are transferred with the digital file data and are checked whether the deletion condition data stored in the memory of the user terminal are satisfied. If the deletion condition is satisfied, the converted file data stored in the memory of the user terminal are deleted.

Thus, it is possible to do rental transaction through the Internet by such a deletion process. Furthermore, the deletion condition data can be set as the available term after receiving the digital file or the available repeat-number. And the deletion process is a process to overwrite a part or all of the digital file data divided and spread in the memory of the user terminal with other data.

And, according to the invention indicated in claim 4 of the present invention, the server for file distribution connected to a user terminal through a communication network according to claim 1 or 3 wherein said management/playback program performing a step of dividing said transferred digital file data into a plurality of data groups by the setting rule,

a step of converting said divided data groups to discontinuously spread data, and

a step of storing said discontinuously spread data in said storage space with said deletion condition data.

According to this file distribution server, there is a management/playback program performing a step of dividing the transferred digital file data into a plurality of data groups by a setting rule, a step of converting the divided data groups to discontinuously spread data, and a step of storing the discontinuously spread data in the storage space with the deletion condition data. Thus, according to this file distribution server, it is very difficult to analyze and restore the digital file data because the data are divided to discontinuously spread data. Therefore, this fact makes it possible to prevent illegal usage of transferred files and piracy by illegal copying and distribution.

And, according to the invention indicated in claim 5 of the present invention, there is a server for file distribution connected to a user terminal through a communication network comprising:

a file data memory having digital file data to be transmitted, a program memory having a computer program managing and playing back the digital file data, a management/playback program stored in the program memory requested from the user terminal, and a transfer processing unit transferring the digital file data stored in the file data memory, wherein the transfer processing unit converting the digital file data requested from the user terminal into data group divided and spread by the setting rule and transferring the converted digital file data to the user terminal, wherein the management/playback program performing a step of setting a storage space of the converted digital file data transferred from the file distribution server into a memory of the user terminal, a step of storing the converted digital file data in the setting storage space, a step of decoding the converted digital file data in the memory of the user terminal to the digital file data by the setting rule, and a step of playing back the decoded digital file data on the user terminal.

If a user terminal accesses the file distribution server via a communication network, and then the server receives requests for distribution of certain or user-selected digital files, the server transfers management/playback program stored in the program memory to the user terminal that accessed the server. Next, when the management/playback program is started on the user terminal, the program makes storage space in the terminal for data that are to be transferred from the file distribution server.

Then, after completing this process, the server transfers the requested digital file data to the user terminal. The digital file data to be transferred are then converted into divided-and-spread data groups by the management/playback program in accordance with a certain setting rule. The digital file data are finally stored in the storage space of the user terminal made in the preceding process. This ends the distribution process of digital file in the file distribution server.

When the digital file data are distributed to the user terminal in the way described above, the user can play back the digital file by starting and running the management/playback program, which is stored in the user terminal. In other words, when the management/playback program is run, the digital file data stored in the memory of the user terminal are re-converted and restored according to the setting rule, and then the restored digital file is played on the user terminal.

Therefore, according to this file distribution server, without the management/playback program, which can re-convert file data by using the setting rule sent with the data, the transferred file cannot be played back because the requested digital file data are converted into divided-and-spread data group according to the setting rule and then transferred. Hence, by converting file data into divided-and-spread data group, analyzing and restoring the data become difficult. Thus, even if transferred digital files (converted digital files) are copied, general playback programs cannot play back the copied files. And, the system makes it possible to effectively prevent illegal use of transferred files and to prevent piracy of the digital file data and distribution.

According to the invention indicated in claim 6 of the present invention, a setting rule, that corresponds to the above setting rule of the file distribution server indicated in claim 5, is unique to each one of its users. By the file distribution server, digital file data cannot be played back without the management/playback program transferred to the user terminal when the file distribution server transfers the management/playback program to some user terminals because the setting rule is unique to each one of its users and each management/playback program is not compatible with other management/playback programs. Therefore, the file distribution server makes it possible to prevent piracy by illegal copying of the transferred digital files among users.

According to the invention indicated in claim 7 of the present invention, there is a transfer processing unit, that corresponds to the transfer processing unit indicated in the above claim 5 or 6, transferring the converted digital file data with a deletion condition data to the user terminal, wherein the management/playback program performs a step of setting a storage space of the converted digital file data and the deletion condition data transferred from the file distribution server into the memory of the user terminal, a step of storing the converted digital file data with the deletion condition data in the storage space, a step of decoding the converted digital file data stored in the memory to the digital file data by the setting rule, a step of playing back the decoded digital file data on the user terminal, a step of comparing the deletion condition, and a step of deleting the converted digital file data stored in the memory of the user terminal when the deletion condition is satisfied.

According to the file distribution server, when the management/playback program is run, the deletion condition data are compared whether satisfied or not. The deletion condition data are transferred with the digital file and stored in the memory of the user terminal. When the deletion condition data are satisfied, the converted file data stored in the memory of the user terminal are deleted.

Furthermore, the deletion condition data can be set as the available term after receiving the digital file or the available repeat-number. And the deletion process is a process to overwrite a part or all of the digital file data divided and spread in the memory of the user terminal with other data. By the file distribution server, it is possible to do rental transaction through the Internet by such a deletion process.

According to the invention indicated in claim 8 of the present invention, there is a transfer processing unit of the file distribution server, that corresponds to the transfer processing unit indicated in claim 5 or 7, dividing the digital file data requested from the user terminal into a plurality of data groups by the setting rule, converting the divided data groups to discontinuously spread data, and transferring the converted digital file data to the user terminal.

According to this file distribution server, the requested digital file data are divided into a plurality of data groups by the setting rule and the divided data groups are converted to discontinuously spread data and the converted digital file data are transferred to the user terminal.

Thus, by the file distribution server, it is very difficult to analyze and restore the digital file data because the data are divided to discontinuously spread data. Therefore, this fact makes it possible to prevent illegal usage of transferred files and piracy by illegal copying and the distribution.

According to the invention indicated in claim 9 of the present invention, there is a transfer processing unit of the file distribution server, that corresponds to the transfer processing unit indicated in the above claim 1 or 8, coding transferring data, and wherein the management/playback program performing a step of decoding the coded transferring data and a step of playing back the decoded transferring data. By the file distribution server, the digital file data to be transferred are coded and then transferred. Therefore, this fact makes it possible to prevent illegal usage of transferred files and piracy by illegal copying and the distribution.

Therefore, a file distribution system having any server for file distribution indicated in the above claim 1 or 9, a user terminal connected through a communication network, makes it possible to effectively prevent illegal use of transferred files and to prevent file piracy and distribution.

Note that the term digital file in this invention corresponds to digital information and data, such as characters, voices, and images, and computer programs. It includes digital music, movies, and novels, and also includes software games.

In addition, the term playback corresponds to the following: (1) outputting music sounds to the speakers of user terminals designed for digital music, (2) showing movies on the displays of user terminals designed for digital movies, (3) showing novels on the displays designed for digital novels, (4) making software games available on the user terminals designed for software games.

### BRIEF DESCRIPTION OF THE DRAWINGS

FIG. 1 is a block diagram showing the general structure of the file distribution system of the present invention for one way of its implementation.

FIG. 2 is a block diagram showing the general structure of the file distribution server for the way of its implementation.

FIG. 3 is a flow chart to demonstrate registering process at the user-registering module for the way of its implementation.

FIG. 4 is a diagram to illustrate the divide-and-spread process of the digital file data for the way of its implementation.

FIG. 5 is a flow chart to illustrate the distribution process at the transferring module for the way of its implementation.

FIG. 6 is a flow chart to show the playback process for the way of its implementation.

FIG. 7 is a flow chart to illustrate the distribution process at the transferring module for another way of its implementation.

FIG. 8 is a flow chart to show the playback process module for another way of its implementation.

### DETAILED DESCRIPTION OF THE PREFERRED EMBODIMENT

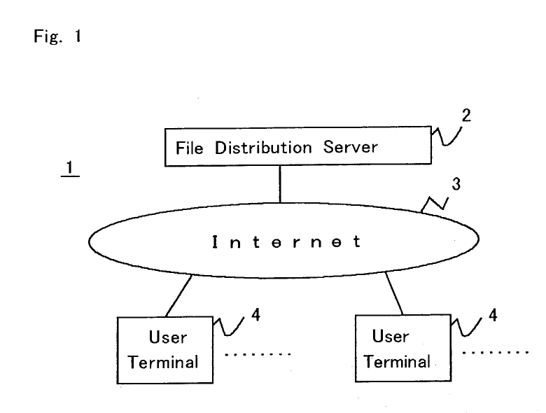

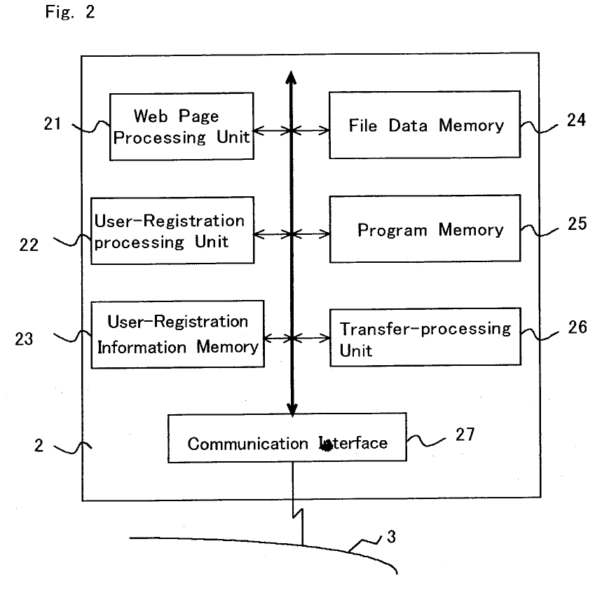

Details of one way of implementation for the present invention will be described below using attached figures. Now, FIG. 1 and FIG. 2 are block diagrams showing the general structures of the file distribution system and the file distribution server for the present implementation, respectively.

As shown in FIG. 1, the file distribution system 1 of this particular way of implementation is composed of file distribution server 2 and multiple user terminals 4, all of which are connected via the Internet 3. The file distribution server 2 functions as a server with CGI script and the Internet servers such as WWW servers. Each of the user terminals 4 functions as a client with browsers.

The file distribution server 2 is a computer with CPU, ROM, RAM, and hard discs. As shown in FIG. 2, it has some function components such as a web page processing unit 21, a user-registration processing unit 22, a user-registration information memory 23, a file data memory 24, a program memory 25, a transfer-processing unit 26, and a communication interface 27. The server is connected to the Internet 3 with the communication interface 27.

The web page processing unit 21 opens up home pages on the Internet 3 for file distribution. Through these home pages, several processes are carried out such as user registration, transference of the management/playback program, and distribution of digital files.

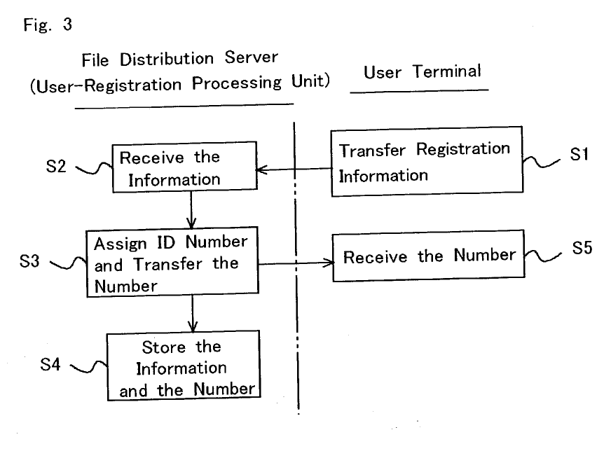

The user-registration processing unit 22 registers system-user information inputted from the user terminals 4 with the home pages. In detail, as shown in FIG. 3, when a user's registration information such as name, address, credit card number, e-mail address, password, etc, is input through the user terminal 4 (step S1), the user-registration processing unit 22 receives the information (step S2). Then the unit assigns an ID number to the user, and transfers it to the user terminal 4 (step S3). Each of the received user information and the assigned ID number is then stored in the user-registration information memory 23 (step S4). The screen of the user terminal 4 displays transferred ID number (step S5) so that the user can commit the number to, for example, writing.

The file data memory 24 stores various digital file data such as information data including characters, voices, and images (novels, essays, music, movies, pictures, paintings, designs, etc), and computer programs (software games).

The program memory 25 stores a management/playback program and a cipher key, which are transferred to the user terminal 4, and are run or used in the terminal. The details of the management/playback program will be described later.

The transfer-processing unit 26 transfers the management/playback program and the cipher key, which are stored in the program memory 25, in response to the request from the user terminal 4. The unit also loads requested digital file data from the file data memory 24, and after adding a deletion condition and ciphering with the cipher key, the unit transfers them to the user terminal 4.

The management/playback program is started on the user terminal 4 and carries out the following six processes. (1) Making the storage space in the memory of user terminal 4 for digital file data to be transferred from the transfer-processing unit 26. (2) Storing the transferred digital file data and deletion condition data into the storage space made in the previous process, after converting them into divided-and-spread data group according to a rule set in advance. (3) Re-storing the converted file data to original digital file data, by re-converting the converted data stored in the memory according to the setting rule. (4) Deciphering the restored digital file data. (5) Playing back the deciphered digital file data on the user terminal 4. (6) Checking if the deletion conditions are fulfilled, and if they are fulfilled, the program deletes the converted file data stored in the memory.

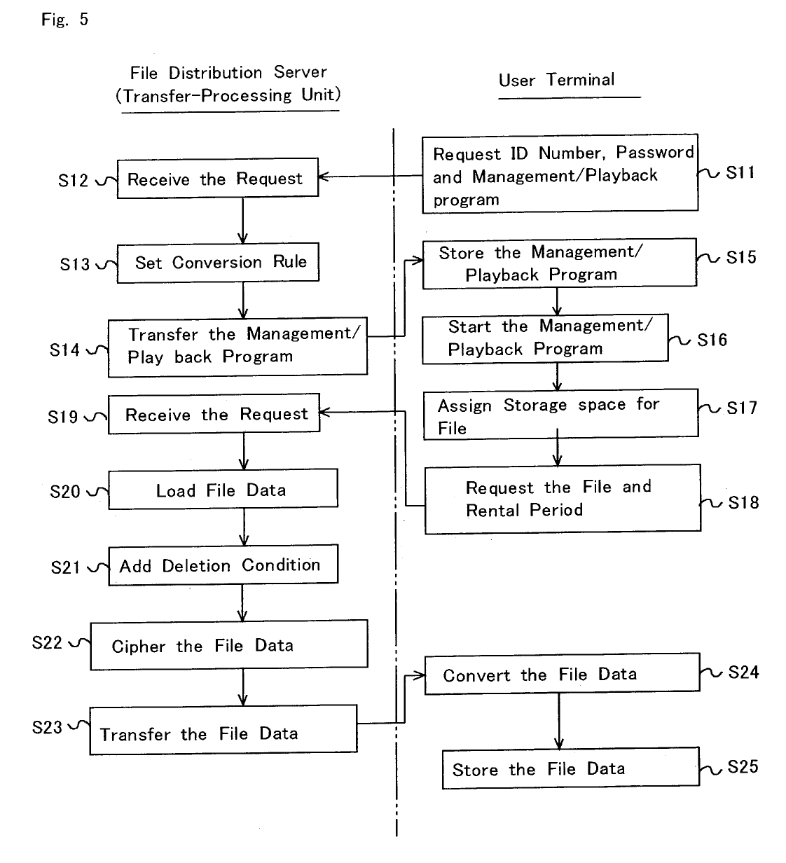

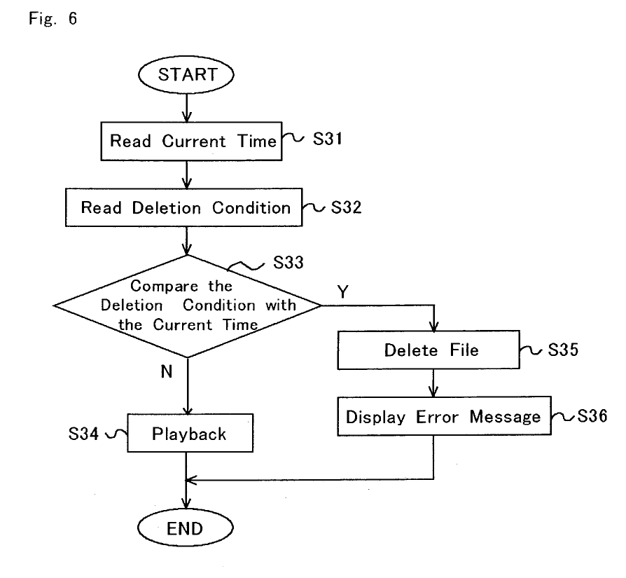

More details of the transfer-processing unit 26 and the management/playback program process will be explained below, using FIG. 5 and FIG. 6.

First, the distribution process of the files is described based on FIG. 5. As shown in FIG. 5, when a user terminal 4 inputs a request for transference of user information such as an ID number and a password or that of a management/playback program via web pages (step S11), the transfer-processing unit 26 receives the request (step S12). Then, the transfer-processing unit 26 loads the requested management/playback program and a cipher key from the program memory 25, and sets a conversion rule for divide-and-spread process of the digital files. The conversion rule is unique to each one of its users' files (step S13). The set conversion rule data is transferred together With the management/playback program and the cipher key to the requesting user terminal 4 (step S14), and then they are stored in the user terminal 4(step S15).

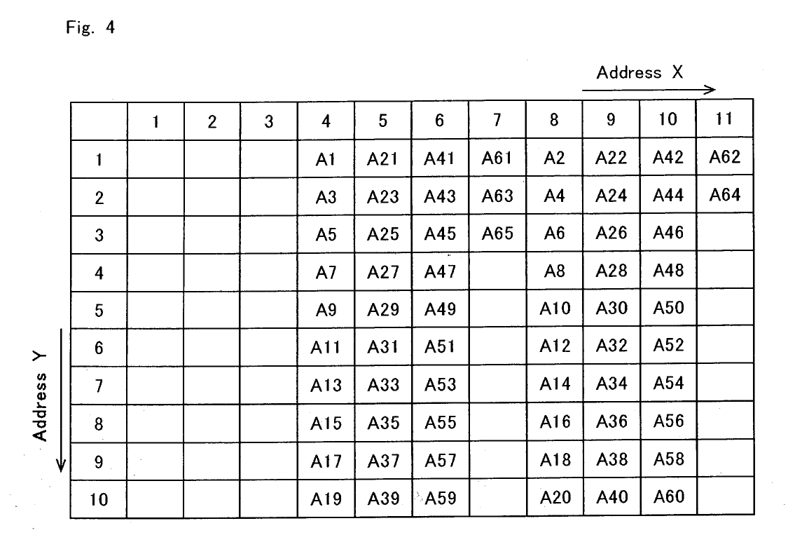

Next, when the transferred management/playback program is started on the user terminal 4 (step S16), this management/playback program makes storage space in the memory of the user terminal 4 for storing digital file data to be transferred from the file distribution server 2 (step S17). Specifically, as shown schematically in FIG. 4, the program sets two-dimensional storage space with addresses in vertical (Y) and horizontal (X) directions. The size of the storage space is adjusted according to the amount of data to be stored in the space.

After the setting of the storage space, the management/playback program makes the user terminal 4 possible to request a file from the file distribution server 2 (step S18). In other words, the program opens communication between the file distribution server 2 and the user terminal 4, and displays a file list, which is stored in the file data memory 24 of the file distribution server 2, on the screen of the user terminal 4. Then, the program makes it possible for user to select files one likes from the displayed list, or to enter the rental period.

Then, after necessary information (file to rent, rental period, etc) is fixed on the user terminal 4(step S18), it is transferred to the file distribution server 2, and received by the transfer-processing unit 26 (step S19).

By receiving the input from the user terminal 4, the transfer-processing unit 26 loads requested digital file data from the file data memory 24 (step S20). Then, the transfer-processing unit 26 adds the deletion condition (the last day of the rental) to the loaded digital file data (step S21), and after ciphering the data, transfers them to the user terminal 4 (step S23). Now, considering the playback process that will be done later, the deletion condition is desirable to be a fixed-size data and to be inserted in the head of the digital file data. Thus, the present invention adopted this procedure.

After receiving the ciphered digital file data and the deletion condition that is added to it, the management/playback program run on the user terminal 4 converts the received data into the divided-and-spread data group according to the conversion rule (file data conversion, step S24). Then, the program stores the data into the storage space so as to make the data discontinuous partly or completely (step S25).

The specific way of the divide-and-spread process is as the following. First, the received data is sequentially divided into segments with predetermined size. Then, the divided data is stored in the memory with the address calculated by the formula,

X=P×α+β,

where P is a constant assigned for and unique to each user, α is an integer that has the value from 1 to n, and β is an integer with the value from 0 to m. Also, n depends on horizontal size of the storage space, and m depends on P. In this case, the conversion rule is this formula, and the term “conversion to divided-and-spread data group” corresponds to the action of storing the digital file data into the storage space after dividing and spreading.

More specifically, the management/playback program sets the address of Y=1 and the value of β=0, and then it changes a sequentially from 1 to n. Using these values, the program calculates address X with the formula shown above, and stores divided data in the storage space corresponding to the calculated address (X, Y=1). Afterwards, changing the address Y from 2 to a fixed maximum value, and setting β=0 and changing a from 1 to n, the program calculates address X. After that process, the program calculates the reminder of the address X by changing β from 1 to M sequentially and iterating the same process. And then the program stores divided data sequentially in the derived address (X, Y).

FIG. 4 shows the way of storing the divided file data (A1-A65) in the addresses calculated above, by setting the maximum value of address X=11, that of address Y=10, P=4, α=1 to 2, and β=0 to 3. The divided file data group is discontinuous in the sense that the divided file data is not stored in the space of address X=1 to 3.

In this way, the term “partly discontinuous” is defined as the state in which there are other data between the divided-file data stored in X-directionally, if the direction of data reading is X-direction. Similarly, the term “completely discontinuous” is defined as the state in which other data are stored in all the spaces between each of the reading-directionally divided file data. The term “other data” in above definitions corresponds to other file data or any data other than file data. Regarding the case shown above, the divided file data would be completely discontinuous if β is set taking only odd or even numbers. In this way, digital file data and deletion condition data attached to it is distributed from the file distribution server 2 to the user terminal 4, and then the data is stored in the user terminal.

The process of playing back the digital file that is stored in the user terminal 4 is described below, based on FIG. 6. When the management/playback program is started on the user terminal 4, and selected to play back the digital file stored in the memory, the playback process in the program is carried out. As shown in FIG. 6, the program reads current time from a clock function in the user terminal 4 (step S31), and then it loads the deletion condition stored in the memory (step S32).

The deletion condition data is inserted at the head of digital file data, and stored in the memory together with the file data after divided and spread.

Therefore, the process of loading the deletion condition data starts with calculating the address X, Y in which the deletion condition data is stored. The address is calculated according to the conversion rule (the above formula). Then the data is deciphered with the cipher key, which is transferred from the server 2 together with management/playback program and stored in the user terminal 4.

Next, current time and the deletion condition data (the final day of the rental) is compared (step S33). If current time is before the final day of the rental, the selected digital files are played back (step S34). On the contrary, if the rental period is passed, the digital file data stored in the memory are deleted (step S35).

The playback consists of three processes: (1) loading of the digital file data that is stored in the memory after dividing and spreading, (2) deciphering of the loaded digital file, (3) playing back of the deciphered digital file data. These processes can be carried out ether in serially/simultaneously, or entirely serially.

The loading process of the digital file data is done in the same way as the loading process of deletion condition data. That is, the addresses X and Y are calculated sequentially according to the conversion rule (the above formula), and the data stored in the address are loaded sequentially. By the way, in the present invention, we denote this loading process as re-converting process. The deciphering process is done similarly based upon the cipher key, which is transferred with management/playback program and stored in the user terminal 4. The playback process (step S34) ceases when the playback of the digital file data is completed.

The term playback corresponds to the following: (1) outputting the music sounds to the speakers of user terminals 4 designed for digital music, (2) showing the movies on the displays of user terminals 4 designed for digital movies, (3) showing the novels on the displays designed for digital novels, (4) making the software games available on the user terminals 4 designed for software games.

The deletion process (step S35) is a process to overwrite a part or all of the digital file data with other data. The address X, Y of the digital file data is determined using the conversion rule (the above formula). After this process, the management/playback program shows error messages on the screen of the user terminal 4, and the messages notify users that the rental period is over, and that the files were deleted (step S36). By this display of error messages, the series of the deletion processes is completed.

As described above, in the file distribution system 1 in this case, the requested digital file data are divided according to the rules (conversion rule) set uniquely for each user, and then stored in the user terminal 4 discontinuously spread. In addition, without the management/playback program that has re-conversion function of digital files based on the rules uniquely set for each user, the distributed file cannot be played back. Thus, even if transferred digital files (converted digital files) are copied, general playback programs cannot play back the copied files. In addition, because each management/playback program does not have compatibility with each other, users cannot play back digital file data that are distributed to other users. Furthermore, by converting file data into divided-and-spread data group, analyzing and restoring the data become highly difficult.

Therefore, by using the file distribution system 1 of this case, pirating of the transferred files becomes meaningless, and this fact makes it possible to prevent illegal usage of transferred files and piracy by illegal copying and the distribution of it.

In addition, the only management/playback program that is necessary to play back the file also carries out the deleting process of the distributed digital file. Therefore, when users run the program in an attempt to play back the digital file that is out of the rental period, the program surely deletes the invalid file. In this way, legal and proper rental can be done.

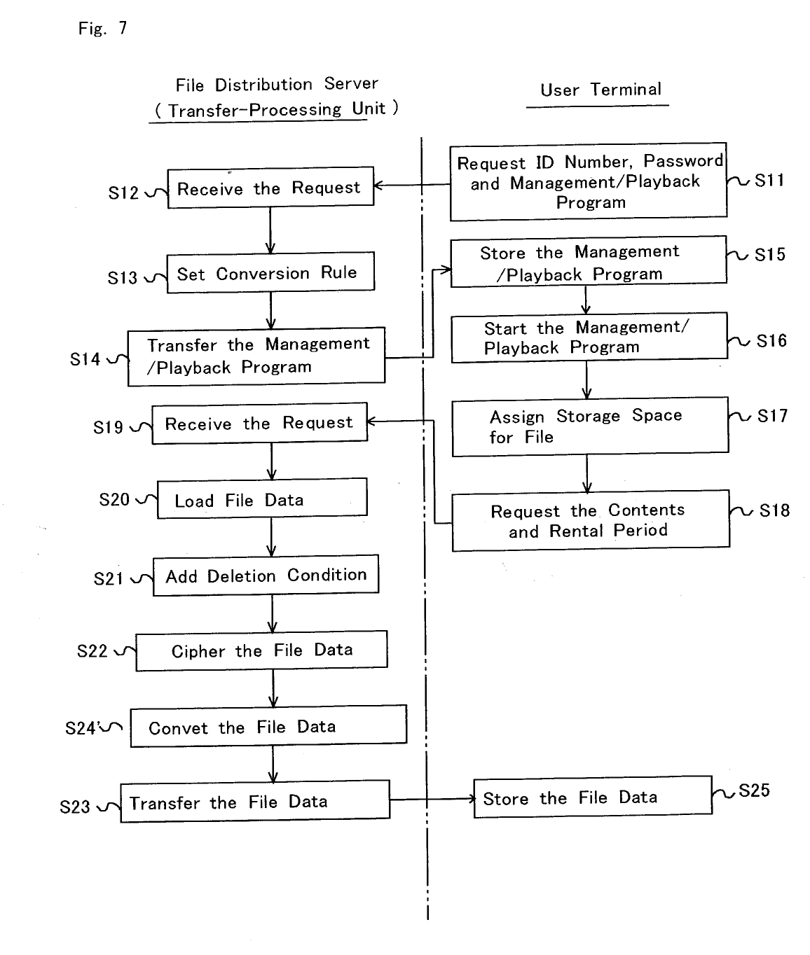

Although so far we explained an example of implementation for the present invention, specific ways of implementation that the present invention can carry out are not limited to the above description. For example, in the above description, the management/playback program that is run on the user terminal 4 divides and spreads (converts) the distributed digital file, and stores it in the memory of user terminal 4. The implementation of the present invention, however, is not limited to the structure described above. As shown in FIG. 7, the divide-and-spread process (file data conversion) can be done in the transfer-processing unit 26 (step S24′). The procedure of the divide-and-spread process can be the same one as described above.

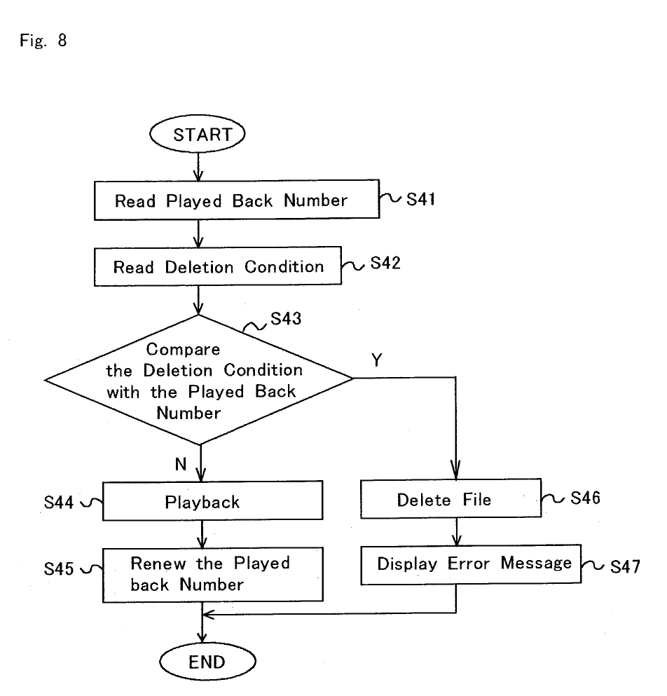

Besides, though the deletion condition is defined as the final day of the rental period in the original explanation, it can be other conditions such as available repeating times of playback. In this case, played-back-number is stored in the memory of user terminals 4. In the playback process, as shown in FIG. 8, the stored played-back-number is read (step S41), and deletion condition stored in the memory is loaded in the same way as the original example (step S42). Then, the played-back-number and the available repeat-number are compared (step S43).

If the played-back-number is less than the available repeat-number, the digital file data are played back (step S44), and the played-back-number is renewed (step S45). On the other hand, if the played-back-number is equal to the available repeat-number, the file is deleted (step S46), and error messages are shown (step S47). The deletion condition (available repeat-number) can be inputted in the step S18 shown in FIG. 5 and FIG. 7, in place of rental-period input.

Although deletion condition data in the original explanation is divided-and-spread as well as digital file data, it is possible to convert only digital file data. In addition, the conversion rule unique to each user is not limited to the formula shown above. For example, the one with a random number is also effective.

Furthermore, although the original case is an example of a rental transaction, the selling transaction of the digital file data is also practical. In this case, the deleting process described above is not necessary.

### Industrial Applicability

In this way, with the file-distribution server, the requested digital file data are stored in user terminals in the form of divided-and-spread data group, which are converted according to the setting rule. Therefore, without the management/playback program, which can re-convert file data by using the setting rule sent with the data, the transferred file cannot be played back.

Thus, even if transferred digital files (converted digital files) are copied, general playback programs cannot play back the copied files. Besides, by converting file data into divided-and-spread data group, analyzing and restoring the data become difficult.

Therefore, the system makes it possible to effectively prevent illegal use of transferred files and to prevent file piracy and distribution.

What is claimed is:

1. A server for file distribution connected to a user terminal through a communication network comprising:
a file data memory having digital file data to be transmitted;
a program memory having a computer program managing and playing back said digital file data;
a management/playback program stored in said program memory requested from said user terminal; and
a transfer processing unit transferring said digital file data stored in said file data memory;
wherein said management/playback program performs a step of setting a storage space of said digital file data transferred from said file distribution server into a memory of said user terminal,
a step of storing said digital file data converted to data group divided and spread by a setting rule in said storage space of said digital file data,
a step of decoding said data group stored in said memory of said user terminal to said digital file data by said setting rule, and
a step of playing back said decoded digital file data on said user terminal.

2. The server for file distribution connected to a user terminal through a communication network according to claim 1 wherein said setting rule is unique to each one of its users.

3. The server for file distribution connected to a user terminal through a communication network according to claim 1 or 2 wherein said transfer processing unit transferring said digital file data requested from said user terminal with a deletion condition data,
said management/playback program performs a step of setting a storage space of said digital file data and said deletion condition data transferred from said file distribution server into said memory of said user terminal,
a step of storing said digital file data converted to data group divided and spread by a setting rule in said storage space with said deletion condition data,
a step of decoding said data group stored in said memory of said user terminal to said digital file data by said setting rule,
a step of playing back said decoded digital file data on said user terminal
a step of comparing said deletion condition, and
a step of deleting said converted digital file data stored in said memory of said user terminal when said deletion condition is satisfied.

4. The server for file distribution connected to a user terminal through a communication network according to any one of claim 1 to 3 wherein said management/playback program performs a step of dividing said transferred digital file data into a plurality of data groups by a setting rule,
a step of converting said divided data groups to discontinuously spread data, and
a step of storing said discontinuously spread data in said storage space with said deletion condition data.

5. A server for file distribution connected to a user terminal through a communication network comprising:
a file data memory having digital file data to be transmitted;
a program memory having a computer program managing and playing back said digital file data;
a management/playback program stored in said program memory requested from said user terminal; and
a transfer processing unit transferring said digital file data stored in said file data memory;
wherein said transfer processing unit converting said digital file data requested from said user terminal into data groups divided and spread by a setting rule and transferring said converted digital file data to said user terminal,
wherein said management/playback program performs a step of setting a storage space of said digital file data transferred from said file distribution server into a memory of said user terminal,
a step of storing said converted digital file data in said setting storage space,
a step of decoding said converted digital file data in said memory of said user terminal to said digital file data by said setting rule, and
a step of playing back said decoded digital file data on said user terminal.

6. The server for file distribution connected to a user terminal through a communication network according to claim 5 wherein said setting rule is unique to each one of users.

7. The server for file distribution connected to a user terminal through a communication network according to claim 5 or 6 wherein said transfer processing unit transferring said converted digital file data with a deletion condition data to said user terminal,
wherein said management/playback program performs a step of setting a storage space of said digital file data and said deletion condition data transferred from said file distribution server into said memory of said user terminal,
a step of storing said converted digital file data with said deletion condition data in said storage space,
a step of decoding said converted digital file data stored in said memory to said digital file data by said setting rule,
a step of playing back said decoded digital file data on said user terminal,
a step of comparing said deletion condition, and
a step of deleting said converted digital file data stored in said memory of said user terminal when said deletion condition is satisfied.

8. The server for file distribution connected to a user terminal through a communication network according to any one of claim 5 to 7 wherein said transfer processing unit dividing said digital file data requested from said user terminal in a plurality of data groups by a setting rule,
converting said divided data groups to discontinuously spread data, and
transferring said converted digital file data to said user terminal.

9. The server for files distribution connected to a user terminal through a communication network according to claim 1 or 8 wherein said transfer processing unit codes data being transferred, and wherein said management/playback program performs a step of decoding said coded transferred data and a step of playing back said decoded transferred data.

10. A file distribution system comprising:
a server for file distribution;
a user terminal connected through a communication network;
wherein said server for file distribution is any server described the above any one of claim 1 to 9.
